(19) United States
(12) Patent Application Publication
(10) Pub. No.: US 2023/0241684 A1
(43) Pub. Date: Aug. 3, 2023

(54) Method for Removing Material from An Additively Manufactured Part

(71) Applicant: Additive Manufacturing Technologies Limited, Sheffield, South Yorkshire (GB)

(72) Inventors: Konstantin Rybalcenko, Sheffield, South Yorkshire (GB); Joseph Gwilliam Crabtree, Sheffield, South Yorkshire (GB)

(21) Appl. No.: 18/001,915

(22) PCT Filed: Jun. 18, 2021
(86) PCT No.: PCT/GB2021/051551

§ 371 Date: Dec. 15, 2022

(30) Foreign Application Priority Data
Jun. 18, 2020 (GB) 2009302.7

(51) Int. Cl. B22F 10/62; B22F 10/43

(52) U.S. Cl. CPC B22F 10/62; B22F 10/43; B33Y 40/20

(57) ABSTRACT

The present application relates to a method and system for removing material from an additively manufactured part. The method comprises providing an additively manufactured part comprising a part section and a support structure, providing a material having an expansible volume, carrying out an application step, wherein the material is applied to the additively manufactured part and carrying out a de-coupling step, wherein the material is expanded from a first, unexpanded, state to a second, expanded, state so as to generate a separating force for de-coupling the part section and the support structure.

### PRIORITY CLAIM

The present application is a U.S. National Stage patent application of International Patent Application No. PCT/GB2021/051551, filed Jun. 18, 2021, which claims priority to United Kingdom Application No. 2009302.7, filed Jun. 18, 2020, the benefit of which is claimed and the disclosures of which are incorporated herein by reference in their entirety.

### FIELD

The present disclosure relates to a method for removing material from an additively manufactured part and an apparatus for performing the same.

### BACKGROUND

When additive manufacturing methods are used to produce parts exhibiting over-hanging features, such as a lip, it is typical for support structures to be manufactured onto the part during the build of the part, for adding extra support to the overhanging feature. This helps to prevent the structure from collapsing during the build of the part.

This problem is particularly prevalent when performing additive manufacturing processes using particulate build materials such as ceramic or metallic powders (which tend to be heavier than other known build materials), and also when using non powder-based methods such as Fused Filament Deposition Modelling (FFDM or FFF as it is sometimes known).

However, such support structures need to be removed from the additively manufactured product in order to obtain the final finished part.

One method currently used for removing support structures involves manually removing the support structure (e.g. using pliers). However, this method can be a very slow, labor intensive process and can therefore cause a significant reduction in processing efficiency. Furthermore, this method can also risk causing damage to the additively manufactured part and, further still, since support structures can exhibit sharp edges or features, this method can potentially cause an injury to a worker trying to manually remove the support structure.

Another method, typically used in conjunction with additively manufactured polymeric parts, involves manufacturing the support structure from a different material to that of the part. Once the build operation is complete, the additively manufactured part and the support structure are submerged into an acid that is strong enough to dissolve the support structure, but weak enough so as not to dissolve the key features of the additively manufactured part. However, this method is typically only suitable for a limited number of materials (e.g. polymeric materials), and requires two separate material feeds for producing the part and support structure, which can lead to a reduction in process efficiency. This method can also suffer from problems such as acid becoming trapped within areas of the part which, over time, can have deleterious effects on the properties of the part and can also potentially cause injury to a user.

It is therefore an aim of the present disclosure to address at least one of the aforementioned problems.

### SUMMARY

According to a first aspect of the present disclosure, a method for removing material from an additively manufactured part is provided comprising providing an additively manufactured part comprising a part section and a support structure, providing a material having an expansible volume, carrying out an application step, wherein the material is applied to the additively manufactured part and carrying out a de-coupling step, wherein the material is expanded from a first, unexpanded, state to a second, expanded, state, wherein the volume of the material in the expanded state is greater than the volume of the material in the unexpanded state, so as to generate a separating force for de-coupling the part section and the support structure.

Advantageously, the steps of applying an material to an additively manufactured part and then expanding the material so as to generate a separating force for de-coupling the part section and the support structure helps the support structure to be quickly and easily decoupled from the part section without requiring manual intervention. This helps improve processing efficiency and also helps to minimize damage to either the part or the operator.

Furthermore, by using a material to separate the support structure and the part section, the method does not require the use of any potentially harmful chemicals, thereby helping to further reduce the likelihood of damage to either the part or the operator.

In exemplary embodiments, the method comprises selecting a material of a kind such that, during the de-coupling step, the material is expanded from the first, unexpanded, state to the second, expanded, state, such that the volume of the material in the second, expanded, state is 10% greater than the volume of the material in the first, unexpanded state.

Advantageously, expanding the volume of the material by at least 10% helps to remove the support structure more effectively.

In exemplary embodiments, the method comprises selecting a material of a kind such that, during the de-coupling step, the material is expanded from the first, unexpanded, state to the second, expanded, state, such that the volume of the material in the second, expanded, state is 20% greater than the volume of the material in the first, unexpanded state.

Advantageously, expanding the volume of the material by at least 20% helps to remove the support structure even more effectively.

In exemplary embodiments, the method comprises selecting a material of a kind such that, during the de-coupling step, the material is expanded from the first, unexpanded, state to the second, expanded, state, such that the volume of the material in the second, expanded, state is 30% greater than the volume of the material in the first, unexpanded state.

Advantageously, expanding the volume of the material by at least 30% helps to remove the support structure more effectively still.

In exemplary embodiments, the additively manufactured part comprises an interface defined between the part section and the support structure, and wherein the application step comprises applying the material at or about the interface between the support structure and the part section.

Advantageously, it has been found that when the material is located at or about the interface defined between the part section and the support section, the required separating force can be achieved at smaller levels of volumetric expansion of the material, which thereby helps to further improve processing efficiency.

In exemplary embodiments, the material is of a type capable of being expanded upon the application of a fluid.

In exemplary embodiments, the fluid is water.

In exemplary embodiments, the de-coupling step comprises applying a fluid, optionally water, to the material so as to cause the material to expand from the first, unexpanded, state to the second, expanded, state.

Advantageously, the provision of an material which is capable of expansion upon the application of a fluid helps to provide an easy and efficient method for expanding the material, thereby further improving processing efficiency.

In exemplary embodiments, the method further comprises heating the fluid applied to the material to a temperature in the range of 80° C. to 120° C., and optionally to a temperature of approximately 100° C., so as to cause the material to expand from the first, unexpanded, state to the second, expanded, state.

Advantageously, heating the fluid applied to the material to a temperature in the range of 80° C. to 120° C. helps to enact more rapid expansion of the material, thereby further improving processing efficiency.

In exemplary embodiments, the de-coupling step comprises heating the material to a temperature of at least 50° C. so as to cause the material to expand from the first, unexpanded, state to the second, expanded, state.

Advantageously, heating the material to a temperature above 50° C. helps to more rapidly expand the material, thereby improving processing efficiency.

In exemplary embodiments, the de-coupling step comprises heating the material to a temperature in the range of 50° C. to 80° C. so as to cause the material to expand from the first, unexpanded, state to the second, expanded, state.

Advantageously, heating the material to a temperature in the range of 50° C. to 80° C. helps to even more rapidly expand the material, thereby further improving processing efficiency.

In exemplary embodiments, the method further comprises combining the material with a carrier fluid, prior to the application step, and then applying the material and carrier fluid mixture to the additively manufactured part.

Advantageously, the provision of a carrier fluid can help the material to better permeate into gaps between the support structure and the part.

In exemplary embodiments, the carrier fluid may be a liquid.

In exemplary embodiments, the carrier fluid may be water.

Advantageously, when combined with a fluidically-activatable material, the feature of a carrier fluid has the synergistic effect of also helping to achieve more efficient activation of the material since the material can be applied and activated in a single step.

In exemplary embodiments, the carrier fluid may be a gas.

In exemplary embodiments, the carrier fluid may be air.

In exemplary embodiments, the method further comprises pressurizing the carrier fluid, prior to the application step, and then applying the material and carrier fluid mixture to the additively manufactured part as a pressurized fluid jet.

Advantageously, pressuring the carrier fluid can help the material to even better permeate into gaps between the support structure and the part.

In exemplary embodiments, the application step comprises locating the additively manufactured part within a processing chamber and circulating the material and carrier fluid mixture about the processing chamber so as to apply the material to the additively manufactured part.

Advantageously, the step of circulating the material about the processing chamber is generally much easier to perform, and can therefore generally be performed without significant operator input, thereby helping to further reduce operator workload.

In exemplary embodiments, the material is selected from at least one of: a polymeric material; a composite material; a ceramic material; bauxite; silica; glass or a resinous material.

In exemplary embodiments, the material is an expansible proppant (e.g. XOProp).

Advantageously, it has been found that the expandable proppants are particularly effective at removing support structures from additively manufactured parts.

In exemplary embodiments, the material is a particulate material.

Advantageously, by using a particulate material, the material can more easily permeate into gaps between the support structure and the part.

In exemplary embodiments, the particulate material has a roundness of at least 0.5, optionally of at least 0.75 and further optionally of at least 0.9.

In exemplary embodiments, the particulate material has a roundness and/or sphericity of at least 0.5, optionally of at least 0.75 and further optionally of at least 0.9.

Advantageously, by using a particulate material having a roundness and/or sphericity in this range, the material can more easily permeate into gaps between the support structure and the part.

We consider the term “expansible material” to be defined as a material having an expansible volume.

We consider the term “roundness” to be defined as the ratio of the average radius of curvature of a given particle to the radius of curvature of said particle if said particle was a perfect sphere.

We consider the term “sphericity” to be defined as the ratio of the surface area of a given particle to the surface area of a sphere having the same volume.

In exemplary embodiments, the particulate material has a diameter in the range of 0.1 mm to 3 mm.

Advantageously, by using a particulate material having a diameter the range of 0.1 mm to 3 mm, the material can more easily permeate into gaps between the support structure and the part whilst still achieving efficient support structure removal.

In exemplary embodiments, the particulate material has a diameter in the range of 0.2 mm to 0.5 mm.

Advantageously, by using a particulate material having a diameter in the range of 0.2 mm to 0.5 mm, the material can even more easily permeate into gaps between the support structure and the part whilst still achieving efficient support structure removal.

In exemplary embodiments, the particulate material has a diameter in the range of 0.25 mm to 0.45 mm.

Advantageously, it has been found that particulate material having a diameter in the range of 0.25 mm to 0.45 mm are optimal for efficient permeation and support structure removal.

According to a second aspect of the disclosure, there is provided a method of additively manufacturing a part is provided, comprising the steps of additively manufacturing a part comprising a part section and a support structure and de-coupling the support structure from the part section of the additively manufactured part via the method according to the first aspect of the disclosure.

According to a third aspect of the disclosure, there is provided an apparatus for removing material from an additively manufactured part, the apparatus comprising a processing chamber configured for receiving an additively manufactured part, the additively manufactured part comprising a part section and a support structure and an applicator configured to apply a material having an expansible volume to the additively manufactured part.

Advantageously, this apparatus can help to facilitate quick and easy removal of support material from an additively manufactured part without requiring manual intervention, thereby helping to improve processing efficiency and also minimizing damage to either the part or the operator.

Furthermore, the apparatus does not use any potentially harmful chemicals, thereby helping to further reduce the likelihood of damage to either the part or the operator.

In exemplary embodiments, the apparatus further comprises a hopper for storing the material, and the applicator is configured for receiving the material from the hopper for applying to the additively manufactured part.

In exemplary embodiments, the apparatus further comprises a reservoir configured for containing a carrier fluid (e.g. water) and the applicator is further configured for combining the carrier fluid and the material for application to the additively manufactured part.

Advantageously, the feature of a carrier fluid reservoir and an applicator configured to combine the material with the carrier fluid from the carrier fluid reservoir prior to application helps the material to better permeate into gaps between the support structure and the part upon application.

Furthermore, when used in combination with a fluidically-activatable material, this feature has the synergistic effect of helping to facilitating more efficient activation of the material since the material can be applied and activated in a single step.

In exemplary embodiments, the applicator comprises a nozzle configurable for applying the material and carrier fluid mixture onto the additively manufactured part as a pressurized fluid jet.

Advantageously, the feature of a nozzle helps to provide a pressurized flow of material, thereby helping the material to better permeate into gaps between the support structure and the part upon application.

In exemplary embodiments, the applicator comprises a circulator configured to apply the material and carrier fluid mixture onto the additively manufactured part via circulating the material and carrier fluid mixture about the processing chamber.

Advantageously, the feature of a circulator can generally apply the material to the without significant operator input, and thereby helps to further reduce operator workload.

In exemplary embodiments, the apparatus further comprises a heating element configured for heating the material, optionally to a temperature of at least 50° C., and further optionally to a temperature in the range of 50° C. to 80° C., so as to cause the material to expand from a first, unexpanded, state to a second, expanded, state.

Advantageously, the feature of a heating element configured to heat the material helps to facilitate more rapid expansion of the material to be achieved following activation, thereby improving processing efficiency.

In exemplary embodiments, the heating element is configured for heating the carrier fluid such that the material is heated via the carrier fluid, optionally to a temperature of at least 50° C., and further optionally to a temperature in the range of 50° C. to 80° C., so as to cause the material to expand from a first, unexpanded, state to a second, expanded, state.

Advantageously, the feature of a heating element configured to heat the material via the carrier fluid helps the material to be quickly and easily heated to a desired temperature.

In exemplary embodiments, the heating element is configured to heat the carrier fluid to a temperature in the range of 80° C. to 120° C., and optionally to a temperature of approximately 100° C., so as to cause the material to expand from a first, unexpanded, state to a second, expanded, state.

Advantageously, the feature of a heating element configured to heat the material to a temperature in the range of 80° C. to 120° C. helps the material to be quickly and easily heated to a desired temperature.

In exemplary embodiments, the heating element is located at the reservoir,

In exemplary embodiments, the heating element is configured to maintain the reservoir at a pre-determined temperature.

Advantageously, locating the heating element at the reservoir provides a quick and easy way of heating the carrier fluid contained therein.

In exemplary embodiments, the apparatus further comprises a controller configured for controlling the apparatus according to the first aspect of the disclosure.

According to a fourth aspect of the disclosure, there is provided an additive manufacturing apparatus is provided comprising the apparatus according to the third aspect of the disclosure.

According to a fifth aspect of the disclosure, there is provided a system comprising the apparatus according to the third aspect of the disclosure and a material having an expansible volume.

### BRIEF DESCRIPTION OF THE DRAWINGS

Embodiments of the disclosure will now be described with reference to the accompanying drawings, in which:

FIG. 1 is a cross-sectional view of an additively manufactured part having a part section, a support structure and an interface therebetween;

FIG. 2 is a cross-sectional view of an apparatus for removing the support structure from the additively manufactured part of FIG. 1;

FIG. 3 is a schematic flow diagram of a method for removing the support structure from the additively manufactured part of FIG. 1; and

FIG. 4 is a close-up cross-sectional view of the interface of the additively manufactured part illustrated in FIG. 1, after an expansible material has been applied according to the method of FIG. 3.

### DETAILED DESCRIPTION OF EMBODIMENTS

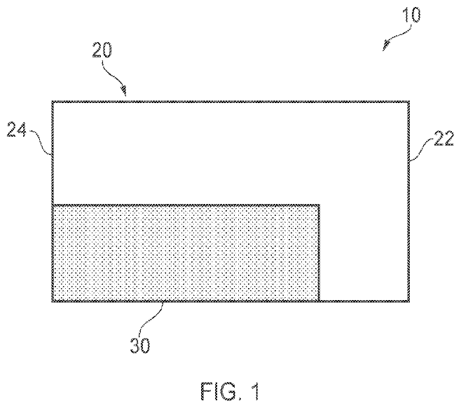

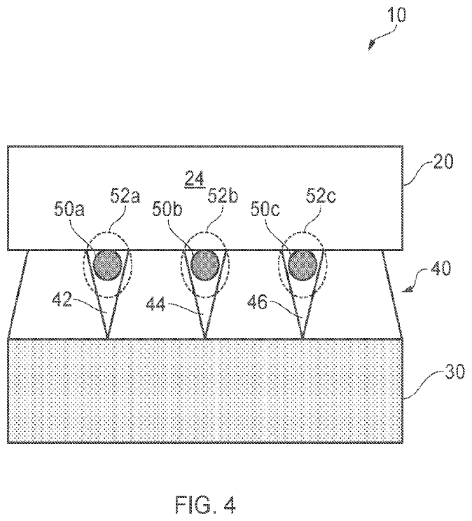

FIG. 1 shows an additively manufactured part 10 having a part section 20, a support structure 30 and an interface 40 therebetween (shown in FIG. 4).

In the embodiment illustrated in FIG. 1, the additively manufactured part 10 has been manufactured using a metallic build material. However, it shall be appreciated that in other embodiments, the additively manufactured part may comprise any other suitable material, such as ceramic or plastics, and may be manufactured using any suitable method.

The part section 20 of the additively manufactured part 10 includes a main body 22 and an overhanging portion 24, which is supported at its lower surface by the support structure 30. In the illustrated embodiment, the overhanging portion 24 is provided in the form of a cantilever extending substantially perpendicularly from the main body 22 of the part section 20. However, it shall be appreciated that in other embodiments, the overhanging portion may be of any other suitable type, such as a lip or other form of protrusion.

The support structure 30 of the illustrated embodiment is provided in the form of a lattice structure. However, it shall be appreciated that any other form of support structure may alternatively be used.

The interface 40 is defined as a perforated region between the support structure 30 and the part section 20 (see FIG. 4).

As has been discussed previously in the background section, in order to obtain the final, finished product, the support structure 30 must be removed from the part section 20.

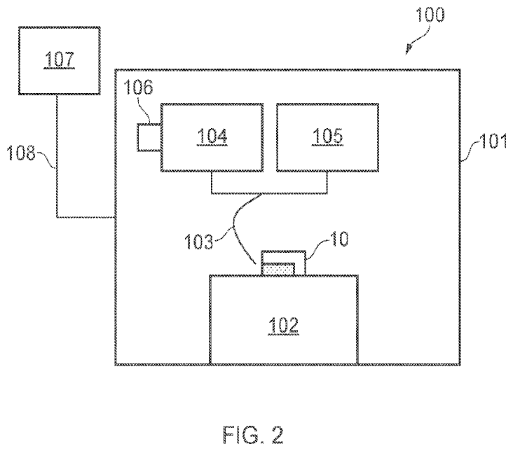

An apparatus for removing the support structure 30 from the part section 20 is shown in FIG. 2.

The apparatus 100 features a processing chamber 101 having a support platform 102 for receiving the additively manufactured part 10, and an applicator configured to apply a material having an expansible volume (hereinafter an expansible material) 50 (see FIG. 4) at or about the interface 40 between the part section 20 and the support structure 30.

In the illustrated embodiment, the applicator is provided in the form of a nozzle 103 which is in fluid communication with a carrier fluid reservoir 104 and a hopper 105 for storing the expansible material 50.

The carrier fluid reservoir 104 is configured to receive and store a carrier fluid for combining with the expansible material 50, stored in the hopper. The carrier fluid containing the expansible material is then applied the additively manufactured part 10, typically at or about the interface 40, via the nozzle 103.

In the illustrated embodiment, the carrier fluid is a liquid (e.g. water). However, in other embodiments, the carrier fluid may be a gas (e.g. gas).

Furthermore, in other embodiments, the applicator may be any other suitable form of applicator. For example, in some embodiments, the application may be a circulator configured to circulate the expansible material around the processing chamber.

The apparatus 100 also includes a heating element 106 configured to heat the expansible material 50 to a temperature of at least 50° C., typically to a temperature in the range of 50° C. to 80° C.

In the illustrated embodiment, the heating element 106 is located at the carrier fluid reservoir 104 and is configured to heat the carrier fluid contained therein such that, when the carrier fluid is combined with the expansible material 50, the expansible material 50 is heated to the desired temperature of at least 50° C., and further optionally to a temperature in the range of 50° C. to 80° C.

In the illustrated embodiment, the heating element is configured to maintain the reservoir at a pre-determined temperature in the range of 80° C. to 120° C., typically approximately 100° C., ready for combining with the expansible material 50. However, it shall be appreciated that in other embodiments, the heating element may be configured to apply heat to the expansible material directly, or further embodiments, the heating element may be omitted.

Furthermore, in other embodiments, the expansible material may also be applied directly to the part 10 without the use of a carrier fluid, and therefore, in such embodiments, the carrier fluid reservoir may also be omitted.

In the illustrated embodiment, the apparatus 100 further includes an additive manufacturing apparatus 107, configured to additively manufacture the part 10, and a transporter 108 for conveying the part 10 from the additively manufacturing apparatus 107 to the support material removal apparatus 100.

Typically, the transporter is provided in the form of a conveyor belt or a robotic arm, configured to transport the part 10 from the additive manufacturing apparatus 107 to the support material removal apparatus 100. However, it shall be appreciated that in other embodiments, any other suitable transportation means may be used, or, in further alternatives, the additive manufacturing apparatus and associated transporter may be omitted.

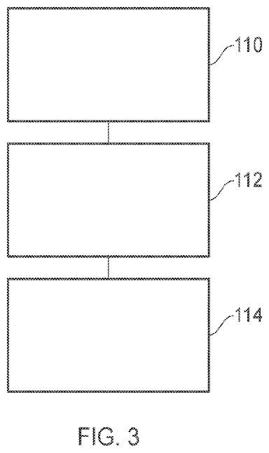

The method for removing the support structure 30 from the part section 20 of the additively manufactured part 10 shall now be described with reference to FIG. 3.

FIG. 3 shows a flow diagram depicting the method of the illustrated embodiment.

In a first step of the method 110, the additively manufactured part 10 is provided. In the illustrated embodiment, the additively manufactured part 10 is manufactured via the additive manufacturing apparatus 107 before being transferred to the processing chamber 101 via the transporter 108. However, it shall be appreciated that in other embodiments, the additively manufactured part 10 may be provided via an entirely separate process, in which case the part 10 may simply be placed into the processing chamber 101.

Once the part 10 has been provided and placed within the processing chamber 101, in step 112 the expansible material 50 is applied to the additively manufactured part 10, typically at or about the interface 40, via the applicator.

In the illustrated embodiment, the expansible material 50 is provided as an expansible particulate material.

Such materials can be made from polymer material, copolymers, composite material, ceramic material, swellable clays, bauxite, silica, glass, resinous materials, hydrogel coated material or a combination of the aforementioned materials comprising a binder or a filler.

A specific example of such an expansible material is the XOProp™ expansible polymeric proppant, manufactured by Terves.

Examples of expansible polymers may include but are not limited to crosslinked polyacrylamide, crosslinked polyacrylate, crosslinked copolymers of acrylamide and acrylate monomers, acrylamide, starches, crosslinked polymers of allylsulfonate, 3-allyloxy-2-hydroxy-1-propanesulfonic acid, acrylics and acrylic acids, salts of crosslinked polymeric materials, copolymers of a crosslinked vinyl silane and at least one water soluble organic monomer, crosslinked cationic water soluble polymers, salts of carboxymethyl starch, salts of carboxymethyl cellulose, salts of crosslinked carboxyalkyl polysaccharide, starch grafted with acrylonitrile and acrylate monomers, copolymers of vinyl silane include, but are not limited to, vinyltrichlorosilane, vinyltris (beta-methoxyethoxy) silane, vinyltriethoxysilane, vinyltrimethoxysilane, methacrylatetrimethoxysilane, methacrylatetriethoxysilane, and any combinations thereof.

Suitable water soluble organic monomers for use with the cross-linked copolymers of vinyl silane include, but are not limited to, 2-hydroxyethyl acrylate, polyalkylacrylate, acrylamide, vinylmethyl ether, methacrylamide, vinylpyrrolidone, and any combinations thereof. Suitable cross-linked cationic water soluble polymers include, but are not limited to, quaternized ammonium salt of polydialkyldiallyl polymers, quaternized ammonium salt of polyethyleneimine polymers, quaternized ammonium salt of polydimethylaminoethyl-methacrylate copolymers, quaternized ammonium salt of poly N-(3-dimethylaminopropyl) acrylamide polymers, and any combinations thereof.

In alternate embodiments, the expansible material may be an organic polymer that expands when an activating agent (e.g. water) is applied to it.

It shall also be appreciated that any other suitable material type may be used.

In the illustrated embodiment, the step 112 of applying the expansible material 50 involves combining the expansible material 50, located in the hopper 105, with a carrier fluid (e.g. water), contained within the reservoir 104. The carrier fluid containing the expansible material 50 is then pressurized and applied at or about the interface 40 via the nozzle 103 of the applicator.

However, in other embodiments, in step 112, expansible material 50 may be circulated around the processing chamber, rather than being injected at a specific location between the part section 20 and the support structure 30 using a nozzle.

The perforated region, which forms part of the interface 40, comprises a plurality of gaps or apertures 42, 44, 46 (as shown in FIG. 4) and so, once the expansible material 50 is applied at or about the interface, the expansible material 50 becomes deposited within the gaps 42, 44, 46 of the interface 40.

It has been found that circulating the expansible material around the processing chamber can help to more thoroughly locate the expansible material 50 in the gaps between the part section and the support structure, as shall be described in greater detail below.

FIG. 4 shows a close-up view of the interface region 40 of the additively manufactured part 10 after the expansible material 50 has been applied.

The expansible, particulate material 50 is of a type having a roundness and sphericity of at least 0.5, although materials having a roundness and sphericity of at least 0.9 may be used to enable the expansible material 50 to more easily permeate into the gaps 42, 44, 46 located at the interface region 40.

In the illustrated embodiment, the plurality of gaps or apertures 42, 44, 46 which form the perforated region of the interface 40 have a width in the range of 0.25 mm to 1.2 mm and a height in the range of 0.7 mm to 0.8 mm. Therefore, the expansible material 50 is chosen to exhibit a suitable size to be received with the gaps or apertures 42, 44, 46. In the case of the illustrated embodiment, the diameter of the particulate material is in the range of 0.1 mm to 3 mm, although it shall be appreciated that this may vary based upon the application and type of support structure used during the additive manufacturing process.

Once the expansible material 50 has been applied to the additively manufactured part, in this case at or about the interface 40, the expansible material 50 is expanded in step 114 form its first, original, volume to a second, expanded, volume which is greater than the first volume. This expansion generates a separating force between the part section 20 and the support structure 30 to allow for the de-coupling of the part section 20 from the support structure 30.

In the illustrated embodiment, the expansible material 50 is of a type capable of being expanded upon the application of a fluid (e.g. water) such that, upon being combined with the carrier fluid (also typically water) and applied at or about the interface 40, the expansible material 50 can be left to expand, without any further operator input being required.

However, it shall be appreciated that in other embodiments, for example where the expansible material is applied without the use of a carrier fluid or using a gaseous carrier fluid, that the method may comprise a further step of activating the expansible material after it has been applied to the interface. In some embodiments, this step may involve wetting the expansible material with a fluid (e.g. water).

It shall also be appreciated that, in some embodiments, the expansible material may be expanded using means other than fluid activation. For example, in other embodiments, the expansible material may be of a type capable of being expanded upon the application of heat, UV light and/or electricity and the step of activating the expansible material may therefore comprise applying heat, UV light and/or electricity to the expansible material.

Once the expansible material 50 has been applied and activated (either via combining with a carrier fluid or via a separate activation step), the expansible material is allowed to expand for a period of at least 4 hours, although in some embodiments the expansible material may be allowed to expand for a period of between 6 and 72 hours.

As illustrated in FIG. 4, the expansible material typically expands from its original, unexpanded volume (as denoted by reference numerals 50a, 50b and 50c) to an expanded volume (denoted by reference numerals 52a, 52b, 52c) which is 10% greater than its original, unexpanded volume, although it shall be appreciated that volumetric expansions of over 20% or 30% can be achieved in some embodiments.

As the expansible material 50 expands, the volume occupied by the material becomes greater than the area available within the gaps 42, 44, 46 at the interface 40. As such, the expansible material 50 begins to urge against the part section 20 and the support structure 30 which creates a separating force which drives the part section 20 and the support structure 30 away from each other.

The perforated region of the interface 40, located between the part section 20 and the support structure 30, is an area of relative weakness in the part 10. Therefore, as the volume of the expansible material 50 expands, the separating force exerted between the support structure 30 and part section 20 will eventually overcome the bond strength between the support structure 30 and the part section 20, thereby causing the two sections to de-couple.

In this manner, the method of the illustrated embodiment helps the support structure to be quickly and easily decoupled from the part section without requiring manual intervention, thereby improving processing efficiency and also minimizing damage to either the part or the operator.

Furthermore, by using an expansible material to separate the support structure and the part section, the method does not require the use of any potentially harmful chemicals, thereby helping to further reduce the likelihood of damage to either the part or the operator. The method is also suitable for a wide range of materials and so provides the further benefit of improved adaptability.

As mentioned above, the expansible material 50 is chosen to exhibit a size small enough to be received within the gaps 42, 44, 46 at the perforated region of the interface, but large enough such that the expansion of the expansible material 50 achieves a sufficient separating force to cause de-coupling of the support structure 30 from the part section 20.

A range of suitable expansible material particle sizes are provided in Table 1, below.

TABLE 1

| | Unexpanded Diameter | Expanded Diameter |
|---|---|---|
| Particle Mesh Size | (mm) | (mm) |
| 10 | 2.00 | 2.60 |
| 40 | 0.42 | 0.55 |
| 45 | 0.37 | 0.47 |
| 50 | 0.30 | 0.39 |
| 60 | 0.25 | 0.33 |
| 70 | 0.21 | 0.27 |
| 80 | 0.18 | 0.23 |
| 100 | 0.15 | 0.19 |

Additionally, to help achieve more rapid expansion of the expansible material 50, and hence more rapid de-coupling of the part section 20 and the support structure 30, the method of may also involve the step of heating the expansible material 50 to a temperature of at least 50° C., typically in the range of 50° C. to 80° C.

In the illustrated embodiment, the expansible material 50 is heated via heating the carrier fluid to a temperature in the range of 80° C. to 120° C., typically via boiling the carrier fluid to a temperature of approximately 100° C. via the heating element 106 whilst the carrier fluid is contained within the reservoir 104.

When the carrier fluid and expansible material 50 are combined, ready for application, the heat of the carrier fluid, which is substantially higher than that of the expansible material 50, causes the expansible material 50 to subsequently heat up into the desired temperature range of 50° C. to 80° C., thereby allowing for more rapid expansion of the expansible material 50.

Although the disclosure has been described above with reference to one or more preferred embodiments, it will be appreciated that various changes or modifications may be made without departing from the scope of the disclosure as defined in the appended claims.

1. A method for removing material from an additively manufactured part, the method comprising:
providing an additively manufactured part comprising a part section and a support structure;
providing a material having an expansible volume;
carrying out an application step, wherein the material is applied to the additively manufactured part; and
carrying out a de-coupling step, wherein the material is expanded from a first, unexpanded, state to a second, expanded, state, wherein the volume of the material in the expanded state is greater than the volume of the material in the unexpanded state, so as to generate a separating force for de-coupling the part section and the support structure.

2. The method according to claim 1, wherein the additively manufactured part comprises an interface defined between the part section and the support structure, and wherein the application step comprises applying the material at or about the interface between the support structure and the part section.

3. The method according to claim 1, wherein the material is of a type capable of being expanded upon the application of a fluid (e.g. water), and wherein the de-coupling step comprises applying a fluid, optionally water, to the material so as to cause the material to expand from the first, unexpanded, state to the second, expanded, state.

4. The method according to claim 3, wherein the method further comprises heating the fluid applied to the material to a temperature in the range of 80° C. to 120° C., and optionally to a temperature of approximately 100° C., so as to cause the material to expand from the first, unexpanded, state to the second, expanded, state.

5. The method according to claim 1, wherein the de-coupling step comprises heating the material to a temperature of at least 50° C., and optionally to a temperature in the range of 50° C. to 80° C., so as to cause the material to expand from the first, unexpanded, state to the second, expanded, state.

6. The method according to claim 1, wherein the method further comprises selecting a material of a kind such that, during the de-coupling step, the material is expanded from the first, unexpanded, state to the second, expanded, state, such that the volume of the material in the second, expanded, state is 10% greater than the volume of the material in the first, unexpanded state, optionally wherein the volume of the material in the second, expanded, state is 20% greater than the volume of the material in the first, unexpanded state 20% and further optionally wherein the volume of the material in the second, expanded, state is 30% greater than the volume of the material in the first, unexpanded state.

7. The method according to claim 1, wherein the material is selected from at least one of: a polymeric material; a composite material; a ceramic material; bauxite; silica; glass or a resinous material; optionally, wherein the material is an expansible proppant (e.g. XOProp).

8. The method according to claim 1, wherein the material is a particulate material; optionally, wherein the particulate material has a roundness and/or sphericity of at least 0.5, optionally of at least 0.75 and further optionally of at least 0.9.

9. The method according to claim 8, wherein the particulate material has a diameter in the range of 0.1 mm to 3 mm, optionally in the range of 0.2 mm to 0.5 mm and further optionally in the range of 0.25 mm to 0.45 mm.

10. The method according to claim 1, wherein the method further comprises combining the material with a carrier fluid, prior to the application step, and then applying the material and carrier fluid mixture to the additively manufactured part.

11. The method according to claim 10, further comprising pressurizing the carrier fluid, prior to the application step, and then applying the material and carrier fluid mixture to the additively manufactured part as a pressurized fluid jet.

12. The method according to claim 10, wherein the application step comprises locating the additively manufactured part within a processing chamber and circulating the material and carrier fluid mixture about the processing chamber so as to apply the material to the additively manufactured part.

13. A method of additively manufacturing a part comprising the steps of:
additively manufacturing a part comprising a part section and a support structure; and
de-coupling the support structure from the part section of the additively manufactured part via the method according to claim.

14. An apparatus for removing material from an additively manufactured part, the apparatus comprising:
a processing chamber configured for receiving an additively manufactured part, the additively manufactured part comprising a part section and a support structure; and
an applicator configured to apply a material having an expansible volume to the additively manufactured part.

15. The apparatus according to claim 14, wherein the apparatus further comprises a hopper for storing the material, and wherein the applicator is configured for receiving the material from the hopper for applying to the additively manufactured part.

16. The apparatus according to claim 14, wherein the apparatus further comprises a reservoir configured for containing a carrier fluid (e.g. water) and wherein the applicator is further configured for combining the carrier fluid and the material for application to the additively manufactured part; optionally, wherein the applicator comprises a nozzle configurable for applying the material and carrier fluid mixture onto the additively manufactured part as a pressurized fluid jet, or wherein the applicator comprises a circulator configured to apply the material and carrier fluid mixture onto the additively manufactured part via circulating the material and carrier fluid mixture about the processing chamber.

17. The apparatus according to claim 14, further comprising a heating element configured for heating the material, optionally to a temperature of at least 50° C., and further optionally to a temperature in the range of 50° C. to 80° C., so as to cause the material to expand from a first, unexpanded, state to a second, expanded, state; optionally, wherein the heating element is configured for heating the carrier fluid such that the material is heated via the carrier fluid, optionally to a temperature of at least 50° C., and further optionally to a temperature in the range of 50° C. to 80° C.; optionally, wherein the heating element is configured to heat the carrier fluid to a temperature in the range of 80° C. to 120° C., and optionally to a temperature of approximately 100° C.

18. The apparatus according to claim 17, wherein the heating element is located at the reservoir, and optionally wherein the heating element is configured to maintain the reservoir at a pre-determined temperature.

19. The apparatus according to claim 14, wherein the apparatus further comprises a controller configured for controlling the apparatus according to the method of any of claims 1 to 12.

20. A system comprising the apparatus according to claim 14 and a material having an expansible volume.
